(19) United States
(12) Patent Application Publication
(10) Pub. No.: US 2007/0210479 A1
(43) Pub. Date: Sep. 13, 2007

(54) Cable manufacturing method

(76) Inventors: Leo P. McIntyre, La Quinta, CA (US); Craig A. Pfefferman, Simi Valley, CA (US); Douglas P. Cronin, Toluca Lake, CA (US)

Correspondence Address: CISLO & THOMAS, LLP, 233 WILSHIRE BLVD, SUITE 900, SANTA MONICA, CA, 90401-1211, US

(21) Appl. No.: 11/374,707

(22) Filed: Mar. 13, 2006

(51) Int. Cl. B32B 1/00; B32B 15/04

(52) U.S. Cl. 264/171.13; 264/171.14

(57) ABSTRACT

A cable manufacturing method includes feeding bundles of core wires into a wire tensioning apparatus, applying even tension on the fed bundles before extrusion, and extruding the evenly tensioned core wire bundles into a cable with a substantially D-shaped cross-section. Other steps include providing a cable take up spool, and winding the extruded cable in overlapping layers onto the take up spool such that overlapping D-shaped cross-sections of wound cable are lined up directly on top of each other in a controlled fashion to prevent cable deformation.

### COPYRIGHT NOTICE

Portions of the disclosure of this patent document may contain material that is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND

There exists currently a demand for the manufacture of armored dual balanced line radio frequency transmission cable. This type of cable may be designed for use as part of survivable low frequency communication systems, such as those used in conjunction with homeland security and defense missile silo sites. Cable manufacturers to a large extent have so far failed to respond to client requests for the design and production of such mission-critical cable.

The processes involved in the production of such armored cable must ensure an absolute balance of electronic speed of signal propagation between conductors in a transmission line as well as between transmission lines. Manufacturing such a cable would require a special set of tools and procedures to ensure that the cable remains functional before, during and after a nuclear impact. The production methods, tests and procedures utilized must assure continuous and reliable cable performance under extreme conditions of pressure and distortion.

Not every cable manufacturer is ready and willing to expend the substantial time and funds required to meet a very stringent set of cable manufacturing specifications imposed by clients. For example, the reliable performance of inner cable core shields must be absolutely assured due to significant electromagnetic and radio frequency interference under distress conditions. Moreover, the cable armor should be capable of protecting the dual balanced line transmission capabilities of the cable at all times under any type of adverse conditions.

### SUMMARY

Some exemplary embodiments disclosed herein are generally directed to a cable manufacturing method.

In accordance with one aspect of the invention, the cable manufacturing method comprises the steps of feeding one or more bundles of core wires into a wire tensioning apparatus, applying even tension on the core wire bundles before extrusion, and extruding the evenly tensioned core wire bundles into a cable with a D-shaped cross-section.

In accordance with another aspect of the invention, the cable manufacturing method further comprises the step of winding the extruded cable in overlapping layers onto a take up spool. The overlapping cable layers are positioned in a controlled fashion directly on top of each other to prevent cable deformation.

In accordance with yet another aspect of the invention, the cable manufacturing method also comprises the steps of providing a cable take up spool, and winding the extruded cable in overlapping layers onto the take up spool such that overlapping D-shaped cross-sections of wound cable are lined up directly on top of each other in a controlled fashion to prevent cable deformation.

These and other aspects of the invention will become apparent from a review of the accompanying drawings and the following detailed description of the invention.

### BRIEF DESCRIPTION OF THE DRAWINGS

The present invention is generally shown by way of reference to the accompanying drawings in which:

FIG. 1 is a perspective partially cut away view of an armored dual balanced line radio frequency transmission cable manufactured in accordance with the present invention;

FIG. 2 is a cross-sectional view taken along section line 2-2 of FIG. 1;

FIG. 3 is a schematic representation of one stage in the manufacturing process of the cable of FIG. 1;

FIG. 4A is a schematic representation of another stage in the manufacturing process of the cable of FIG. 1;

FIG. 4B is an exploded view of a portion of equipment being used in the cable manufacturing stage of FIG. 4A;

FIG. 4C is a perspective view of equipment being used in the cable manufacturing stage of FIG. 4A;

FIG. 4D is a schematic operational representation of the cable manufacturing stage of FIG. 4A; and

FIG. 4E is a side elevation of an integral level wind arm being used in the cable manufacturing stage of FIG. 4A.

### DETAILED DESCRIPTION

The detailed description set forth below in connection with the appended drawings is intended as a description of exemplary embodiments and is not intended to represent the only forms in which the exemplary embodiments may be constructed and/or utilized. The description sets forth the functions and the sequence of steps for constructing and operating the exemplary embodiments in connection with the illustrated embodiments. However, it is to be understood that the same or equivalent functions and sequences may be accomplished by different embodiments that are also intended to be encompassed within the spirit and scope of the present invention.

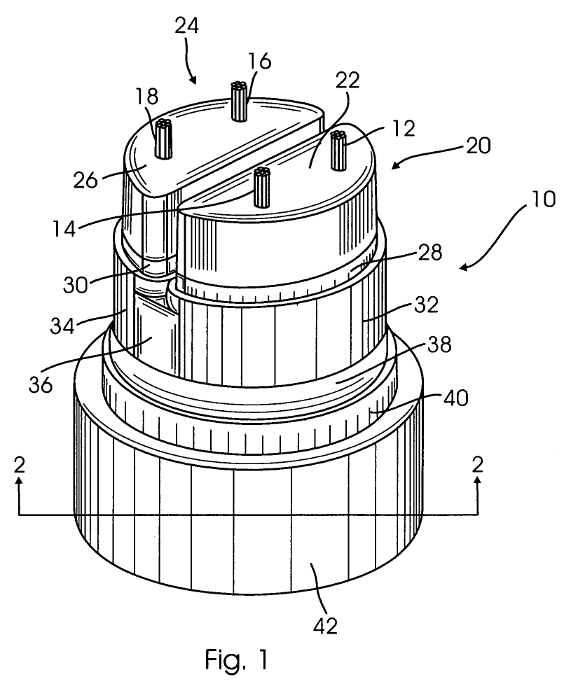

Some embodiments of the present invention will be described in detail with reference to a cable manufacturing method, as generally shown in FIGS. 1-4E. Additional embodiments, features and/or advantages of the invention will become apparent from the ensuing description or may be learned by practicing the invention. In the figures, the drawings are not to scale with like numerals referring to like features throughout both the drawings and the description.

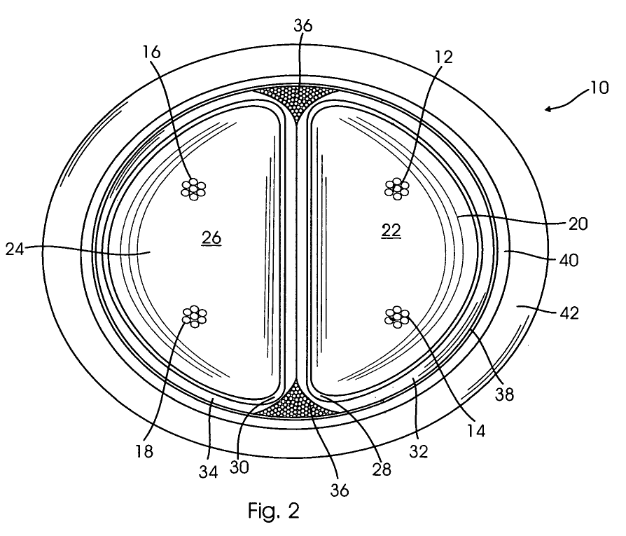

FIG. 1 is a perspective partially cut away view of an armored dual balanced line radio frequency (RF) transmission cable 10 manufactured in accordance with the present invention. Armored RF transmission cable 10 comprises four stranded conductors 12, 14, 16, and 18 which are symmetrically disposed in pairs. Each conductor (12, 14, 16, 18) is made from a bundle of core wires, as generally shown in reference to FIGS. 1-2. In one embodiment, a core bundle contains six wire strands grouped around a central wire strand. Other suitable core wire bundle configurations may be utilized, as needed.

Each conductor pair is disposed in its own cable partition and includes one tinned copper conductor and one bare copper conductor embedded in dielectric material. Specifically, partition 20 includes tinned copper conductor 12 and bare copper conductor 14 embedded in dielectric material 22 which is extruded with a half-moon or D-shaped cross-section, as generally illustrated in FIGS. 1-2. Similarly, partition 24 includes bare copper conductor 16 and tinned copper conductor 18 embedded in dielectric material 26 which is extruded with a matching half-moon or D-shaped cross-section.

Each dielectric extrusion (22, 26) is shielded with helically applied bare copper tape (28, 30) and covered with a polyethylene jacket (32, 34), respectively. Jute fillers 36 with epoxy resin fill the interstices of (shielded and jacketed) partitions 20, 24 to round off the cable core. In one embodiment, Mylar® tape 38 (FIGS. 1-2) is wrapped around (shielded and jacketed) partitions 20, 24 and jute fillers 36 to hold the cable core intact. Other suitable materials may be utilized to hold the cable core together, as needed. The taped cable core is inserted into a hollow cylindrical armor layer 40 which is formed from seam welded and drawn bare copper tape. An environmentally resistive polyethylene outer jacket 42 is applied on top of armor layer 40 (FIGS. 1-2).

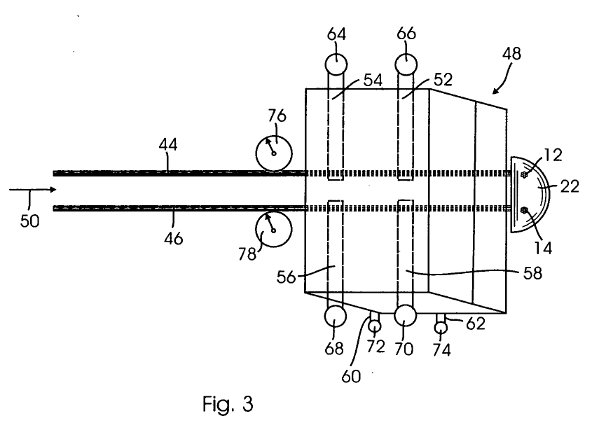

FIG. 3 schematically represents one stage in the manufacturing process of armored dual balanced line RF transmission cable 10. Particularly, elongated core wire bundles 44, 46 are being fed in a substantially parallel fashion into a wire tensioning apparatus 48, as generally indicated by directional arrow 50 in FIG. 3. Apparatus 48 applies even tension on core wire bundles 44, 46 via at least two pairs of oppositely disposed integral torque screws, such as torque screws 52, 54, 56, 58, 60, 62 of FIG. 3. Terminology used herein such as “applying tension” may be generally defined as the application of stress that produces elongation of an elastic physical body. The amount of tension applied on core wire bundles 44, 46 may be adjusted by manually rotating torque screw heads 64, 66, 68, 70, 72, 74 while observing the meter scales on tension gauges 76, 78. In case of observed wire tension differential, the feed line may be stopped, the amount of applied tension adjusted, and the feed line restarted.

Tension gauges 76, 78 are operatively coupled to core wire bundles 44, 46, respectively, upstream from apparatus 48, as schematically illustrated in FIG. 3. Feeding core wire bundles 44, 46 through apparatus 48 ensures that core wire bundles 44, 46 are evenly tensioned before the bundles are extruded from dielectric material with a half-moon or D-shaped cross-section. In this regard, FIG. 3 schematically shows dielectric extrusion 22 with a half-moon or D-shaped cross-section and integral conductors 12, 14 being represented by embedded core wire bundles 44, 46.

Applying even tension on core wire bundles 44, 46 prevents the formation of undesirable kinks in the wires which ultimately affect the electrical properties (e.g., impedance) of the embedded core wires. Tensioning evenly wire bundles 44, 46 ensures that the bundles stay in place during extrusion, i.e. wires do not flop around undesirably. The application of even tension also ensures that the lengths of the extruded (embedded) wire bundles are exactly the same, i.e. signal speed is not affected. Wire tensioning before extrusion is an essential factor in formation of a dual balanced line under a stringent set of cable specifications imposed by client(s).

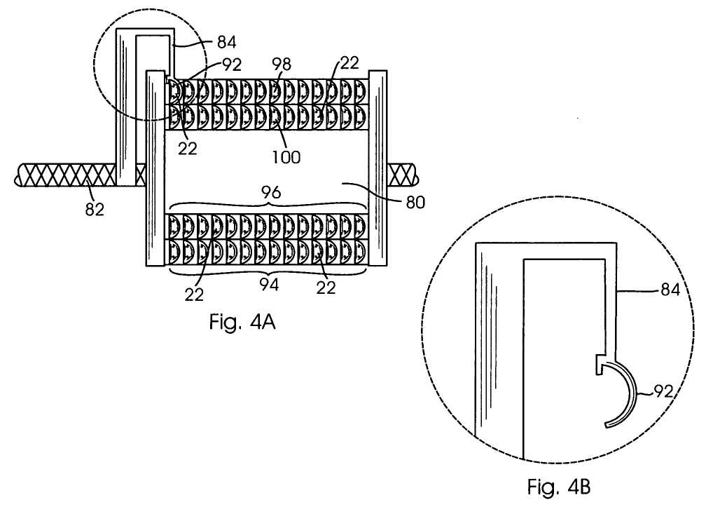

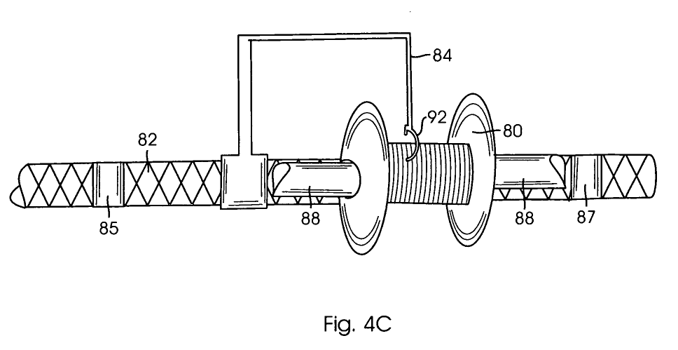

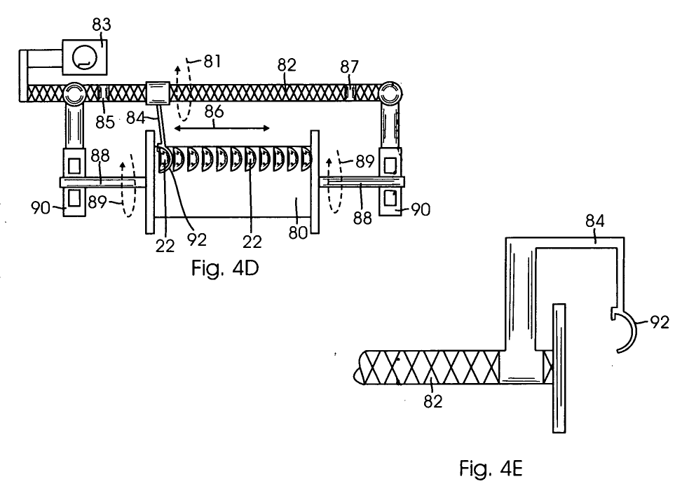

FIGS. 4A-4E schematically represent another stage in the manufacturing process of armored dual balanced line RF transmission cable 10. A cable take up spool 80 is operatively disposed in front of a double threaded screw rod 82, as generally shown in FIGS. 4A, 4C and 4D. Double threaded screw rod 82 is driven by a motor 83 (FIG. 4D) with speed control, and rotates clockwise, as generally shown by rotational arrow 81 in FIG. 4D. Take up spool 80 is also driven by a motor with speed control (not shown). Take up spool 80 is equipped with a shaft 88 which is pivotally coupled at each end to a rack spool holder 90 (FIG. 4D). Spool shaft 88 also rotates clockwise, as generally shown by rotational arrows 89 in FIG. 4D.

A level wind arm 84 (FIGS. 4A-4E) is configured at one end to move linearly back/forth on double threaded screw rod 82 between left and right stop bushings 85, 87, as generally indicated by bi-directional arrow 86 in FIG. 4D, while double threaded screw rod 82 rotates continuously in a clockwise direction. Specifically, as screw rod 82 rotates clockwise, level wind arm 84 advances linearly on one thread of screw rod 82 from left to right until it makes contact with right stop bushing 87. At that point, it reverses direction and moves linearly from right to left on the other thread of screw rod 82 until it makes contact with left bushing 85, at which point it reverses direction again, and so forth.

Level wind arm 84 is configured at another end to hold upright extruded dielectric cable with a half-moon or D-shaped cross-section, i.e. with the flat portion of the D-shaped cross-section being substantially parallel to the inner flange walls of take up spool 80. Extruded dielectric cable of this type is generally shown, for example, at 22 in FIGS. 1-3, 4A, 4D. Particularly, level wind arm 84 is equipped with an integral hook-like cable holder 92 which conforms to the shape of the half-moon cross-section of extruded dielectric cable 22. Hook-like cable holder 92 is adapted to receive and securely hold extruded dielectric cable 22 while cable 22 is being pulled by rotating take up spool 80 for winding thereon. To prevent dielectric cable distortion/deformation during winding, hook-like cable holder 92 is configured to position each successive cable layer directly on top of a preceding cable layer, as schematically shown, for example, in reference to FIG. 4A, while take up spool 80 and double threaded screw rod 82 rotate clockwise in a synchronized fashion.

To achieve such positional capability, the rotational motor speeds of take up spool 80 and double threaded screw rod 82 are synchronized such that cable holder 92 (which is part of level wind arm 84) moves linearly behind take up spool 80 at a sufficient speed to allow the upright placement (positioning) of extruded dielectric cable layers directly on top of each other. Depending on the size of extruded cable and take up spool, the two motors may be synchronized to enable the upright winding of as many cable layers, as needed. In one embodiment, the take up spool is adapted to receive four layers of upright dielectric extruded cable with a half-moon cross-section under strict positional (placement) control via linearly moving cable holder 92.

FIG. 4A schematically shows a top wound layer 94 of extruded dielectric cable 22 positioned upright directly over a bottom wound layer 96 of extruded dielectric cable 22 in accordance with the general principles of the present invention. There is no crossing over of one layer of wound cable onto another. Specifically, respective top and bottom D-shaped cross-sections, such as 98 and 100, of wound cable layers are shown lined up directly on top of each other (FIG. 4A) to prevent cable distortion/deformation. There is no flipping of cable on itself, as practiced conventionally.

An insignificant momentary S-shaped cable flip may occur at terminal spool flange points such as when a new cable layer is started on top of another layer by synchronized cable holder 92. Conventional cable winding on a take up spool does not employ synchronized positional control, as contemplated by the present invention. As a result, there may be moderate to significant impairment of the electrical properties of the finished cable especially under strict cable performance specifications imposed by clients.

Such strict cable performance specifications may include, for example, DC (Direct Current) conductor resistance not to exceed 1.7 Ω/1000 ft. of completed continuous cable with the resistive unbalance between two conductors in a pair being not more than 10%. The total effective shunt capacity between two conductors in a pair should not exceed 12 pF/ft. The capacitive unbalance between the two pairs of conductors should be a maximum of 5%. Each finished cable should have no less than 40 db “far-end” isolation between transmission lines in a 300 ft length over a frequency range of 10 kc to 70 kc. The armor resistance should not exceed 0.5 Ω/1000 ft. of cable. The dielectric strength should be sufficient to withstand the following applied peak impulse voltages: (a) 10 kV (conductor-to-conductor); (b) 10 kV (conductor-to-shield); (c) 50 kV (shield-to-armor); and (d) 10 kV (shield-to-shield). Additional cable performance criteria may apply, as needed.

A person skilled in the art would appreciate that the exemplary embodiments described hereinabove are merely illustrative of the general principles of the present invention. Other modifications and/or variations may be employed that reside within the scope of the invention. Thus, by way of example, but not of limitation, alternative configurations may be utilized in accordance with the teachings herein. Accordingly, the drawings and description are illustrative and not meant to be a limitation thereof.

All terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Thus, it is intended that the invention cover all embodiments and variations thereof as long as such embodiments and variations come within the scope of the appended claims and their equivalents.

1. A cable manufacturing method, comprising the steps of:
feeding at least one bundle of core wires into a wire tensioning apparatus;
applying even tension on said at least one bundle of core wires before extrusion; and
extruding said at least one evenly tensioned bundle of core wires into a cable with a substantially D-shaped cross-section.

2. The cable manufacturing method of claim 1, further comprising the step of operatively coupling at least one tension gauge upstream from said wire tensioning apparatus.

3. The cable manufacturing method of claim 2, wherein tension is being applied via a plurality of torque screws while said at least one core wire bundle passes through said wire tensioning apparatus.

4. The cable manufacturing method of claim 1, wherein passing said at least one bundle of core wires through said wire tensioning apparatus helps prevent the formation of undesirable wire kinks.

5. The cable manufacturing method of claim 3, wherein said torque screws are integral to said wire tensioning apparatus.

6. The cable manufacturing method of claim 1, wherein said at least one evenly tensioned bundle of core wires is extruded from dielectric material.

7. The cable manufacturing method of claim 5, further comprising the step of adjusting the applied tension while observing said at least one tension gauge.

8. The cable manufacturing method of claim 7, wherein the applied tension is adjusted by rotating said integral torque screws.

9. The cable manufacturing method of claim 7, further comprising the step of stopping the core wire feed line in case of observed wire tension differential.

10. The cable manufacturing method of claim 1, wherein said at least one evenly tensioned bundle of core wires stays in place during extrusion.

11. The cable manufacturing method of claim 1, wherein the inclusion of said even tension application step ensures that the lengths of extruded wire bundles remain substantially the same.

12. A cable manufacturing method, comprising the steps of:
feeding at least one bundle of core wires into a wire tensioning apparatus;
applying even tension on said at least one bundle of core wires before extrusion;
extruding said at least one evenly tensioned bundle of core wires into a cable with a substantially D-shaped cross-section; and
winding said extruded cable in overlapping layers onto a take up spool, said overlapping cable layers being positioned in a controlled fashion directly on top of each other to prevent cable deformation.

13. The cable manufacturing method of claim 12, wherein respective top and bottom D-shaped cross-sections of wound cable layers are lined directly on top of each other to prevent cable distortion.

14. The cable manufacturing method of claim 12, further comprising the step of providing a double threaded screw rod.

15. The cable manufacturing method of claim 14, further comprising the step of operatively disposing the take up spool in front of said double threaded screw rod.

16. The cable manufacturing method of claim 15, wherein the take up spool is being rotationally driven by a first motor with speed control.

17. The cable manufacturing method of claim 16, wherein said double threaded screw rod is being rotationally driven by a second motor with speed control.

18. The cable manufacturing method of claim 17, further comprising the step of providing a level wind arm.

19. The cable manufacturing method of claim 18, further comprising the step of providing left and right stop members on said double threaded screw rod.

20. The cable manufacturing method of claim 19, further comprising the step of adapting said level wind arm at one end to move linearly back and forth on said double threaded screw rod between said left and right stop members while the take up spool and said double threaded screw rod rotate in the same angular direction in a synchronized fashion.

21. The cable manufacturing method of claim 20, further comprising the step of adapting said level wind arm at another end to hold upright said extruded cable, said upright holding position being defined by the flat portion of said D-shaped cross-section being substantially parallel to the inner flange walls of the take up spool.

22. The cable manufacturing method of claim 21, wherein said level wind arm is equipped with a hook-like cable holder which conforms to the shape of said D-shaped cross-section of said extruded cable.

23. The cable manufacturing method of claim 22, wherein said hook-like cable holder is adapted to receive and securely hold said extruded cable while said extruded cable is being pulled by the rotating take up spool for winding thereon.

24. The cable manufacturing method of claim 23, wherein said hook-like cable holder positions each successive cable layer directly on top of a preceding cable layer as said level wind arm moves linearly back and forth on said double threaded screw rod between said left and right stop members while the take up spool and said double threaded screw rod rotate in the same angular direction in a synchronized fashion.

25. A cable manufacturing method, comprising the steps of:
feeding at least one bundle of core wires into a wire tensioning apparatus;
applying even tension on said at least one bundle of core wires before extrusion;
extruding said at least one evenly tensioned bundle of core wires into a cable with a substantially D-shaped cross-section;
providing a cable take up spool; and
winding said extruded cable in overlapping layers onto said cable take up spool such that overlapping D-shaped cross-sections of wound cable are lined up directly on top of each other in a controlled fashion to prevent cable deformation.
